(19) United States
(12) Patent Application Publication
(10) Pub. No.: US 2013/0048081 A1
(43) Pub. Date: Feb. 28, 2013

(54) COMPOSITE INFLOW CONTROL DEVICE

(71) Applicants: Gaurav Agrawal, Aurora, CO (US); Anil K. Sadana, Houston, TX (US); Luis A. Garcia, Kingwood, TX (US)

(72) Inventors: Gaurav Agrawal, Aurora, CO (US); Anil K. Sadana, Houston, TX (US); Luis A. Garcia, Kingwood, TX (US)

(73) Assignee: BAKER HUGHES INCORPORATED, Houston, TX (US)

(21) Appl. No.: 13/214,790

(22) Filed: Aug. 22, 2011

(51) Int. Cl. F16L 55/027

(52) U.S. Cl. 137/1; 138/40

(57) ABSTRACT

A flow control device, including a flow path for a fluid therethrough; a geometry defining at least a portion of the flow path, the geometry operatively arranged to cause a pressure drop in the fluid thereacross; a material disposed along the flow path, the material having a surface energy less than that of an undesirable component of the fluid. A method of controlling inflow of an undesirable fluid including: receiving a fluid in a flow control device; and reducing an undesirable component of the fluid flowing out from the flow control device by directing the fluid along a flow path of the flow control device, the flow path at least partially defined by a geometry operatively arranged to cause a pressure drop in the fluid thereacross and at least partially defined by a material having a surface energy less than that of the undesirable component of the fluid.

### BACKGROUND

Downhole completions are often used to produce or harvest fluids, e.g., hydrocarbons, from subterranean reservoirs, formations, or production zones. There are often undesirable fluids, e.g., water or brine, also located downhole. As a result, inflow control devices have been contemplated for limiting production of the undesirable fluids in order to maximize the yield of the desirable fluids. Although useful for impeding some amount of water or other undesirable fluid flow, current inflow control devices only partially eliminate the flow of undesirable fluids. Accordingly, advances in inflow control devices and other systems and methods for limiting undesirable fluid flow into a downhole production assembly are well received by the industry.

### BRIEF DESCRIPTION

A flow control device, including a flow path for a fluid therethrough; a geometry defining at least a portion of the flow path, the geometry operatively arranged to cause a pressure drop in the fluid thereacross; a material disposed along the flow path, the material having a surface energy less than that of an undesirable component of the fluid.

A flow control device, including a flow path for a fluid therethrough; a first material defining at least a first portion of the flow path, the first material having a first surface energy; and a second material defining at least a second portion of the flow path, the second material having a second surface energy, the fluid including an undesirable component having a third surface energy, the first surface energy being less than the third surface energy, and the second surface energy being greater than the third surface energy.

A method of controlling inflow of an undesirable fluid including: receiving a fluid in a flow control device; and reducing an undesirable component of the fluid flowing out from the flow control device by directing the fluid along a flow path of the flow control device, the flow path at least partially defined by a geometry operatively arranged to cause a pressure drop in the fluid thereacross and at least partially defined by a material having a surface energy less than that of the undesirable component of the fluid.

### BRIEF DESCRIPTION OF THE DRAWINGS

The following descriptions should not be considered limiting in any way. With reference to the accompanying drawings, like elements are numbered alike:

FIG. 1 is a quarter-sectional view of a flow control device; and

FIGS. 2A-2D are various embodiments of flow paths for flow control devices, each flow path at least partially defined by both a pressure drop inducing geometry and a low surface energy material.

### DETAILED DESCRIPTION

A detailed description of one or more embodiments of the disclosed apparatus and method are presented herein by way of exemplification and not limitation with reference to the Figures.

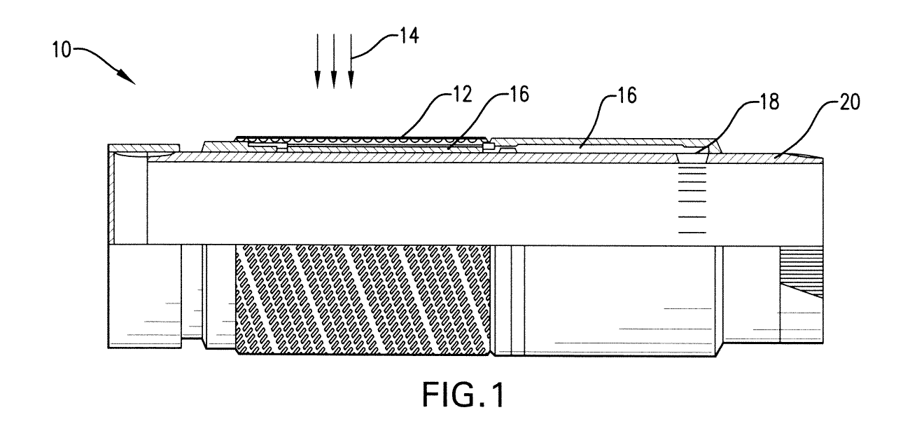

Referring initially to FIG. 1, there is shown a flow control device 10. The flow control device 10 is shown to include a shroud, filtering device, or screen 12 for reducing the amount and size of particulates entrained in a formation fluid 14 entering the flow control device 10 via openings in the screen 12. Once entering the flow control device 10 via the screen 12 or some other opening, the formation fluid 14 flows down a path 16 formed in the flow control device 10. The path terminates in a plurality of ports 18 in a tubular 20.

The tubular 20, is, for example, part of a production tubing string arranged for pumping the formation fluid to the surface. That is, the flow control device 10 is included in a fluid production system installed in a borehole drilled through the earth proximate one or more production zones or reservoirs where the formation fluid 14 is stored. For example, the formation fluid 14 includes oil or other hydrocarbons, the production of which is intended. Multiple copies of the flow control device 10 are positionable along a production string for drawing in formation fluids from the surrounding reservoirs.

The flow control device 10 is used to govern one or more aspects of flow of one or more fluids from the production zones into the tubular 20. As used herein, the term “fluid” or “fluids” includes liquids, gases, hydrocarbons, multi-phase fluids, mixtures of two of more fluids, water, and fluids injected from the surface, such as water. Additionally, references to water should be construed to also include water-based fluids, e.g., brine or salt water. Subsurface formations typically contain water, brine, or other undesirable fluids along with oil or other desirable fluids. For the sake of discussion “water” may be used to generally represent any undesirable fluid, while “oil” may be used to generally represent any desirable fluid, although other fluids may be desirable or undesirable in other embodiments. Often, water will begin to flow into some of the flow control devices 10 after formation fluids have been drawn out of a reservoir or production zone for a certain amount of time. The amount and timing of water inflow can vary along the length of the production zone and from zone to zone. It is therefore desirable to have flow control devices that will restrict the flow of undesirable fluids in response to higher percentages of undesirable fluid flow. Thus, the flow control device 10, as discussed in more detail below, is arranged to restrict or impede the water component of the formation fluid 14 in order to enable a higher percentage of oil to be produced over the life of production zones.

Generally, the flow control device 10 includes a geometry that prohibits, prevents, limits, restricts, impedes or otherwise reduces fluid flow therethrough for providing a pressure drop thereacross. For example, restricted openings, tortuous flow paths, etc., could be formed in or through each flow control device 10. “Tortuous” is intended to mean that the flow path is circuitous, winding, twisting, meandering, labyrinthine, helical, spiraling, crooked, or otherwise indirect. For example, see a variety of devices including tortuous flow paths disclosed in United States Patent Publications 2009/0205834 (Garcia et al.), 2011/0079384 (Russell et al.), 2011/0079396 (Russell et al.), 2011/0079387 (Russell et al.), 2009/0095487 (Xu et al.), and 2009/0277650 (Casciaro et al.), all of which Patent Publications are hereby incorporated by reference in their respective entireties.

Use of these tortuous flow paths and other geometries will create a pressure drop across the flow control device 10, for example, by exploiting differences in densities, viscosities, mobilities, etc., of two or more components of fluid flowing through the devices 10. For example, water is relatively viscous and dense in comparison to oil, and this difference can be exploited with certain geometries, such as those described in the above-incorporated references, in order to impede the flow of water. For example, geometries and tortuous flow paths may increases frictional forces on the fluid due to an increased amount of surface area from the indirect nature of the flow path, cause creation of eddies or dead spots, etc. The undesirable fluid component, having a lower (or higher, depending on the embodiment), density, viscosity, etc., will be impeded more than the desirable component that has a higher (or lower, depending on the embodiment) density, viscosity, etc. In this way, a relatively higher percentage of the desirable component can be obtained.

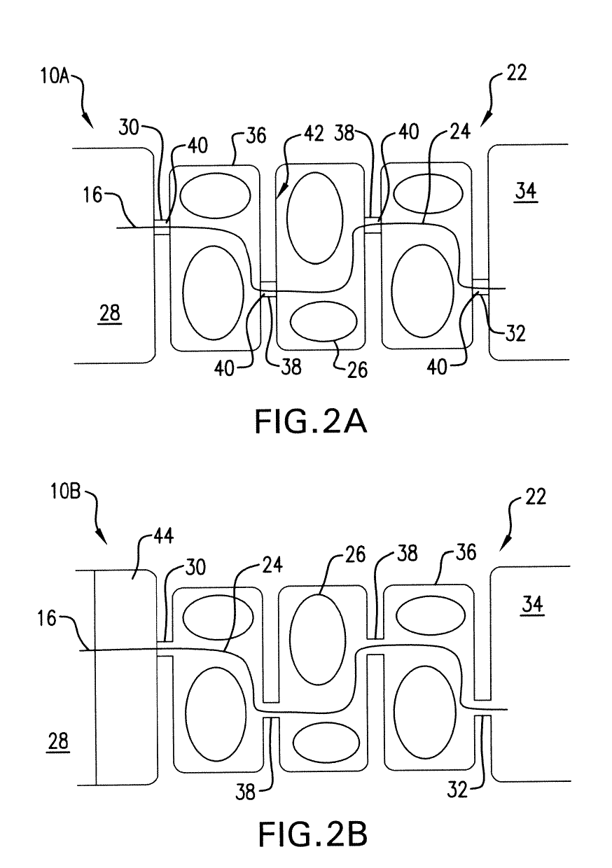

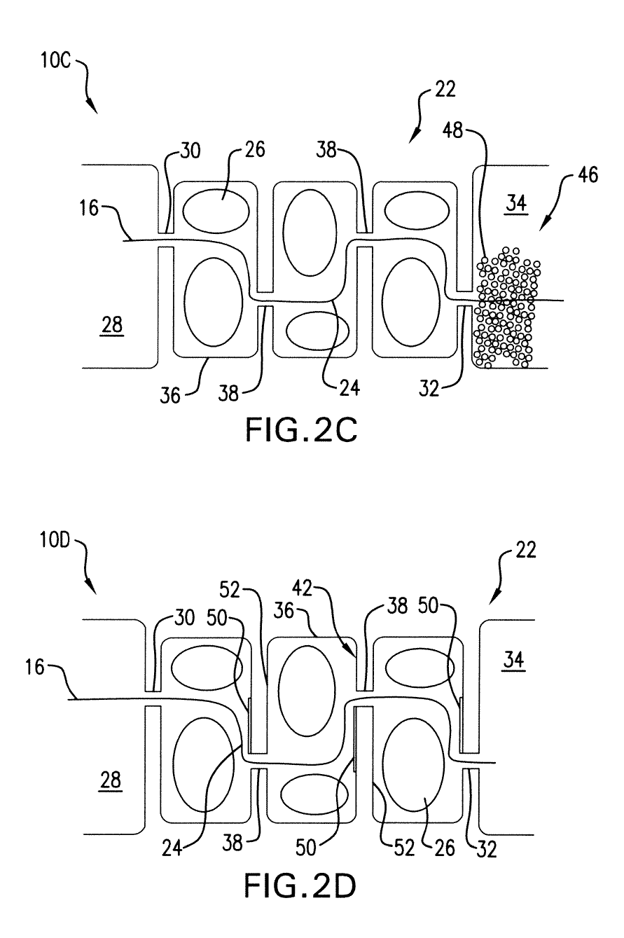

For example, a geometry 22 is shown for a variety of flow control devices 10A-10D in FIGS. 2A-2D, respectively. It is to be appreciated, as discussed above, geometry resulting in a pressure drop can be formed in any number of ways. Accordingly, the geometry 22 shown in FIGS. 2A-2D is provided as one example only and is not to be considered limiting. The geometry 22 defines a tortuous portion 24 of the path 16. The geometry 22 enables creation of dead spots, loops or eddies in the fluid as schematically indicated in areas 26. The portion 24 of the flow path 16 is defined from an inflow area 28 (in fluid communication with the screen 12, and/or the formation, zone, or reservoir holding the fluid 14), through an inlet or opening 30, and out through an outlet or opening 32 into an outflow area 34 (in fluid communication with the ports 18, the tubular 20, and/or the production string). Between the inlet 30 and the outlet 32, a plurality of chambers 36 are included having openings 38 arranged to enable fluid communication between adjacent ones of the chambers 36. For example, the openings 30, 32, and 38 are staggered or offset from each other for making the portion 24 of the path 16 indirect or tortuous.

In addition, according to the current invention, each of the devices 10A-10D includes a portion of the fluid path that is defined by a low surface energy material (i.e., the fluid must flow by, past, across, through, around, or is otherwise affected or influenced by the low surface energy material). As used herein, “low surface energy material” refers to a material that has a surface energy less than that of the fluid flowing through the flow control device or an undesirable component of the fluid. For example, the fluid could be a combination having a water component and an oil component, with the low surface energy material having a surface energy less than that of both water and oil, or less than that of just water. For example, polytetrafluoroethylene (PTFE), super hydrophobic PTFE or other fluoropolymers, polyvinylidene chloride (PVDC), polyether ether ketone (PEEK), poly(methyl methacrylate) (PMMA), cross-linked polyphenylene, and other polymers or materials having relatively low surface energies (e.g., less than about 45-50 mN/m) could be used as low surface energy materials. For example, various electrolytic and CVD treatments are available for modifying the surface energy of some non-polymeric materials. The remaining portions that define the flow path 16 could be high surface energy materials. For example, there is any number of metals, ceramics, polymers etc., that have surface energies greater than that of water and other fluids. Fluids will tend to wet, or spread thinly over surfaces made from materials having relatively higher surface energies. On the other hand, molecules of fluids will tend to “stick” together and form into droplets, spheres, or balls when contacting surfaces having relatively lower surface energies. Coupling the wetting and droplet formation behaviors of fluids with tortuous paths and other geometries enables improved control of pressure drops across and flow of both desirable and undesirable fluid components through flow control devices.

In FIG. 2A, a plug 40 is arranged in each opening 30, 32 and 38. The plugs 40 are formed from low surface energy materials. For example, they could be formed from a porous low surface energy material, such as porous PTFE, for enabling fluid to flow therethrough. In this way, water will want to “stick” together instead of flowing through the plugs 40. Furthermore, the creation of eddies in the areas 26 is also promoted by the geometry 22. By forming walls 42 of the chambers 34 from a relatively high surface energy material, the water will wet the walls 42 and thus want to “stick” to the walls 42 instead of flowing through the plugs 40. The oil, however, will more readily wet the low surface energy material of the plugs 40 and flow therethrough. Of course, it is to be appreciated that variations are possible. For example, the plugs 40 could be only partially block fluid flow, and thus also or alternatively be formed from non-porous low surface energy materials. In other embodiments, only one or some of the openings 30, 32, and 38 could be arranged with the plugs 40. As another example, the device 10A could include numerous geometries defining numerous flow path branches, with each branch having different arrangements of the plugs 40 for providing different pressure drops across each branch.

The low surface energy material could alternatively or additionally be sequentially located along the flow path 16 with respect to the pressure drop geometry features, e.g., the geometry 22. For example, the flow control device 10B includes a formation 44 of low surface energy material disposed in the inflow area 28, before the flow path 16 enters the tortuous portion 24. The formation 44 is included, for example, as a block, sleeve, etc. of porous, low surface energy material for reducing an amount of water or other relatively high surface energy fluid therethrough. Alternatively, another sequentially arranged embodiment is shown in FIG. 3C. That is, the flow control device 10C includes a formation 46 of low surface energy material located in the outflow area 34. The formation 46 is included, for example, as a plurality of pellets 48. The pellets 48 could be any shape, such as rectangular, spherical, cylindrical, irregular, etc., and could be formed from porous or non-porous low surface energy material. As another example, the pellets 48 could be formed from a core of a first material, for example, a metal, ceramic, or other high surface energy material, coated with a low surface energy material. Of course, in other embodiments there could be any combination of blocks, sleeves, pellets, etc. of any size located at any position along the flow path 16, sequentially arranged with the geometry 22 or included along the portion 24, such as in the chambers 36, inflow area 28, outflow area 34, etc.

The flow control device 10D is shown in FIG. 3D. The flow control device 10D includes a plurality of coatings 50 formed from low surface energy materials formed on portions of some of the walls 42 of the chambers 36. Specifically, the coatings in the flow control device 10D are located on the wall 42 directly opposite each of the openings 30, 32, and 38. In this way, the water or other undesirable fluid component is encouraged to form eddies or dead zones in the areas 26 that are bordered by uncoated, high surface energy walls. Of course, other portions of the walls 42, the entirety of the chambers 36, the inflow and outflow areas 28 and 34, etc., could include coatings of low surface energy material resembling the coatings 50. Additionally, it is to be appreciated that features of the geometry 22, such as ribs 52, could be formed from low surface energy material.

The embodiments of FIGS. 3A-3D are accordingly provided as examples only in order to identify some features along the flow path 16 that can be formed from, coated by, or packed with low surface energy materials. It is to be further appreciated in view of the above discussed embodiments that pressure drop across the flow control devices will passively or automatically change depending on the composition of the formation fluid. For example, formation fluid entering a flow control device having a 50/50 split of oil and water will have a higher pressure drop than formation fluid having a 70/30 split of oil and water. Advantageously, however, this pressure drop results primarily from the flow of water being impeded, while the oil is relatively unimpeded. Accordingly, a resulting flow from the flow control devices can be made to have higher percentages of the desired flow component, e.g., oil, than was present in the entering formation fluid. It is also to be appreciated that any combination of the features of the above embodiments and other arrangements of geometries and low surface energy materials are within the scope of the current claims. Furthermore, similar to embodiments discussed in several of the references incorporated above, each flow control device could include a plurality of flow path branches traversing a plurality of different geometry and low surface energy arrangements for providing different pressure drops across each branch. Further, each of these branches could be selectively closable for enabling flow through only certain ones of the branches.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A flow control device, comprising:
a flow path for a fluid therethrough;
a geometry defining at least a portion of the flow path, the geometry operatively arranged to cause a pressure drop in the fluid thereacross;
a material disposed along the flow path, the material having a surface energy less than that of an undesirable component of the fluid.

2. The device of claim 1, wherein the undesirable component comprises water.

3. The device of claim 2, wherein the material has a surface energy of about 50 mN/m or less.

4. The device of claim 2, wherein the fluid also comprises hydrocarbons.

5. The device of claim 1, wherein the portion of the flow path defined by the geometry is tortuously arranged.

6. The device of claim 5, wherein the geometry comprises a plurality of chambers and a plurality of openings connecting adjacent ones of the chambers, the openings offset from each other.

7. The device of claim 1, wherein the flow path is defined through at least one opening.

8. The device of claim 7, wherein the material is disposed in the at least one opening.

9. The device of claim 1, wherein the material is disposed sequentially with the geometry.

10. The device of claim 1, wherein the material is disposed with the geometry along the portion of the flow path.

11. The device of claim 1, wherein the material is formed as a block or sleeve.

12. The device of claim 1, wherein the material is formed as a plurality of pellets or coatings on pellets.

13. The device of claim 1, wherein the geometry is formed from a second material having a surface energy greater than that of the fluid.

14. A flow control device, comprising:
a flow path for a fluid therethrough;
a first material defining at least a first portion of the flow path, the first material having a first surface energy; and
a second material defining at least a second portion of the flow path, the second material having a second surface energy, the fluid including an undesirable component having a third surface energy, the first surface energy being less than the third surface energy, and the second surface energy being greater than the third surface energy.

15. The device of claim 14, wherein the fluid also includes a desirable component having a fourth surface energy.

16. The device of claim 15, wherein the fourth surface energy is greater than the first surface energy.

17. The device of claim 15, wherein the fourth surface energy is less than the first surface energy.

18. The device of claim 14, wherein the second material at least partially forms a geometry, the geometry at least partially defining the flow path and operatively arranged to create a pressure drop in the fluid thereacross.

19. The device of claim 14, wherein the first material at least partially coats or at least partially forms a geometry, the geometry at least partially defining the flow path and operatively arranged to create a pressure drop in the fluid thereacross.

20. A method of controlling inflow of an undesirable fluid comprising:
receiving a fluid in a flow control device; and
reducing an undesirable component of the fluid flowing out from the flow control device by directing the fluid along a flow path of the flow control device, the flow path at least partially defined by a geometry operatively arranged to cause a pressure drop in the fluid thereacross and at least partially defined by a material having a surface energy less than that of the undesirable component of the fluid.
